(19) United States
(12) Patent Application Publication
(10) Pub. No.: US 2016/0238792 A1
(43) Pub. Date: Aug. 18, 2016

(54) FIBRE COUPLER FOR CREATION OF HIGH TEMPERATURE-RESISTANT INTERFEROMETERS AND HIGH TEMPERATURE-RESISTANT INTERFEROMETER

(71) Applicants: Inphotech sp. o. o., Warszawa (PL); Fibrain sp. z o. o., Rzeszów (PL)

(72) Inventors: Anna LOZANSKA, Bratkowice (PL); Michal DLUBEK, Annopol (PL); Jan KALISZ, Rzeszow (PL); Katarzyna GIBALA, Rzeszow (PL); Alicja LESKO, Rzeszow (PL); Katarzyna Joanna PAWLIK, Warszawa (PL); Malgorzata OLSZEWSKA, Warszawa (PL); Zbigniew HOLDYNSKI, Warszawa (PL); Michal SZYMANSKI, Warszawa (PL); Michal MURAWSKI, Warszawa (PL); Lukasz OSTROWSKI, Nieporet (PL); Tadeusz TENEDERENDA, Warszawa (PL); Tomasz NASILOWSKI, Warszawa (PL); Marek NAPIERALA, Wroclaw (PL)

(21) Appl. No.: 15/025,857

(22) PCT Filed: Sep. 28, 2014
(86) PCT No.: PCT/PL2014/050060

§ 371 Date: Mar. 29, 2016

(30) Foreign Application Priority Data
Sep. 30, 2013 (PL) P.405485

(51) Int. Cl. G02B 6/293; G01B 9/02; G02B 6/28; G02B 6/30; G02B 6/36

(52) U.S. Cl. CPC G02B 6/29398; G02B 6/30; G02B 6/3628; G02B 6/29346; G02B 6/2835; G01B 9/02049

(57) ABSTRACT

Fibre coupler for creation of optical fibre-containing interferometers (sensors), with at least two parallel optical fibres placed in an enclosure characterized in that each of the optical fibres consists of at least three alternately placed light-conductive sections with different coatings, at least one (1) of which has a melting point above 200° C., and the two corresponding sections (2) with coating other than with a melting point above 200° C. are coupled using any known method. Interferometer containing above described fibre couplers, where the fibre couplers are interconnected by at least two optical fibre sections (8, 9) with a high temperature-resistant coating.

The subject of the invention is a fibre coupler for creation of interferometers and an interferometer for working in high temperatures and an aggressive environment. The interferometer that is the subject of the patent consists of at least one, preferably two, fibre couplers. The invention is to be used in fiber optic sensors that utilize the interference effect, the so-called interferometer sensors.

The optical fibre that constitutes the basis of well-known fibre couplers and, as a result, a fibre coupler-containing interferometer, consists of a core, cladding and coating. The core, the most internal part of the optical fibre, is usually characterized by a higher refractive index than the fibre's cladding. Both the core and the cladding are usually made of silica glass, whereas the core usually contains additives for rising the refractive index against the cladding's refractive index. The coating of optical fibre is adjacent to the cladding and protects the fibre from bad environmental conditions, damage, etc., as well as provides proper cladding modes radiation. The most common coatings of optical fibres are made from polymers, e.g. acryl, or metals, e.g. copper.

There are devices used in fiber optic sensors, which have the form of fibre couplers created by putting together optical fibres, heating them and stretching, which causes the cores to come together and the light between them to couple. Prior to creating the fibre coupler, the section, where the coupling will take place, is deprived of its coating using known mechanical thermal or other methods.

The typical example of such group of fibre couplers is the fibre coupler found in the description of invention JP2002250837 resistant to high temperatures (up to approx. 250-300° C.) and humidity, in which the optical fibres are seamed and held together by attaching them to the fixing element. The coupler is made using a specific Young module adhesive, utilizing the optical fibre tensile force proper for the fibres' strength. The glue is cured using UV light, however the invention also provides for curing using pressure at room temperature.

The description of JP2003195092 contains information on a fibre coupler to use in harsh weather conditions and underwater, where metal-coated optical fibers are coupled. Such fibre coupler contains many hermetically-sealed metal-coated optical fibres and the connection is secured at the strengthening element inside a metal enclosure.

A different fiber optic coupler creation method can be found in application CN102520485, where the optical fibres are first grinded and then coupled by heating and extending them, creating a “very reliable fibre coupler with proper (correct) temperature characteristics.”

Yet another fiber optic coupler creation method can be found in application CN101408644, where optical fibres are heated and locally narrowed, and then fitted in a U-shaped groove in a quartz base using thermosetting adhesive. The entire fibre coupler rests inside a stainless steel enclosure.

A different solution is presented in patent EP0525743, where optical fibres are coupled together after removing their coatings by locally heating and tapering the optical fibres, and then gluing them to the first substrate, creating a connection, which is then fixed onto a second substrate.

Currently known solutions allow for creating fiber optic couplers resistant to temperatures of up to 300° C. Above that, the cladding surrounding the core deteriorates, thus dissipating the signal. The exception to that are metal-coated optical fibres, however coupling them by heating and tapering the optical fibers is very difficult due to the changes in mechanical properties of the core and the cladding. Both become fragile and non-resistant to tensions formed in the glass due to the changes of temperatures or mechanical loads. Known attempts at improving this parameter are down to modifying the chemical composition of the glass used for creation of the optical fibre, however any additives lowering the fragility are considered contaminants lowering the optical parameters of the fibre.

At least one fibre coupler, preferably two, connected by optical fibre sections create an interferometer, which can be used in interferometer sensors. Optical fibres connecting the fibre couplers are called interferometer arms. The technological problem when creation optical fiber interferometers is the limit in distance, at which another coupler can be made on the same fibres, thus making it hard to manufacture the highly-sought short-arm interferometer sensors.

Designing a high temperature-resistant interferometer is necessary where conditions require the use of such interferometer sensors. The issue of designing such high temperature-resistant interferometer is directly related to the design of high temperature resistant fibre couplers, because interferometers are made using couplers. For example, one coupler-based Michelson or Sagnac interferometer or two coupler-based Mach-Zehnder interferometer.

That is why the goal was to design a fibre coupler for the creation of interferometers, which could be used to create sensors operating in high temperatures.

The fibre coupler for creation of interferometers (sensors) containing optical fibres consists of at least two parallel optic fibers in an enclosure, each consisting of at least 3 alternately placed optical fibre sections, each section in a coating different to the one adjacent to it, with at least one with a melting point above 200° C., preferably metal. Adjacent sections with coatings other than those with a melting point above 200° C. and coatings with a melting point above 200° C., preferably metal, are connected using any known method, preferably by splicing. Preferably each optical fiber should contain two sections in a non-metallic, preferably polymer, coating, with a dividing section with a melting point above 200° C., preferably metal. The non-metallic, preferably polymer-coated optic fiber sections are used to create fibre couplers. Couplers are made using known technologies.

Coupler-containing optical fiber sections are fixed to the substrate, preferably glass. The substrate is gutter- or pipe-shaped and the fibers are permanently attached to it at least in the adjacent area using a high-temperature adhesive, preferably of Resbond 940 LE characteristics. The optical fibers, together with the substrate, are put inside a capillary, preferably glass, and glued to it, preferably with a high-temperature adhesive with a low thermal expansion index. Preferably, the capillary holes, which the optical fibers run through, are additionally sealed with a sealant preferably resistant to high temperatures, preferably silicone, silicone foam, rubber or soft resin.

According to the invention, the interferometer contains fibre couplers interconnected using at least two sections of optical fibers. Opticalfibers running through the couplers contain at least two optical fiber sections with a polymer coating, and outside of the capillary couplers there are at least two optical fiber sections with a high temperature-resistant coating, preferably metal, permanently interconnected with polymer-coated sections.

Optical fiber section that constitute the interferometer arms have the same or positively different length.

According to the invention, the fibre coupler and the interferometer solve the problem of coupling high temperature-resistant fibers, preferably in metal coatings, which is technologically difficult to execute due to fragility of such optical fibers. The design of the fibre coupler and the interferometer in accordance with the invention makes it possible to omit the problem of creating the coupler on optical fibers with high temperature-resistant coating, especially metal. At the same time, the interferometer arms are made of optical fibers with high temperature-resistant coatings, which allows for using the interferometer as a sensor, where increased temperature resistance is required. The couplers themselves are made on optical fibers with non-metallic, preferably polymer coating, which allows to adapt the well-known coupler creation technologies.

The creation of fibre couplers constituting the interferometer can be executed separately, i.e. individual fibre couplers are interconnected (e.g. by splicing using sections of optical fibres with high temperature-resistant coating, constituting the arms of the interferometer) or by splicing different coating types of optical fibers sections, in sequence: non-metallic, preferably polymer, high-temperature resistant, preferably metallic, and again non-metallic, preferably polymer, high-temperature resistant, preferably metallic, and again non-metallic, preferably polymer. The creation of fibre couplers utilizing the 2nd configuration enables maintaining small distances between fibre couplers, which is beneficial from the point of view of sensory operation.

Achieving an alternating sequence of elements constituting the fibre couplers and the interferometer arms is also possible through executing the interferometer on identical sections of polymer-coated optical fibres and then metallizing the interferometer arms.

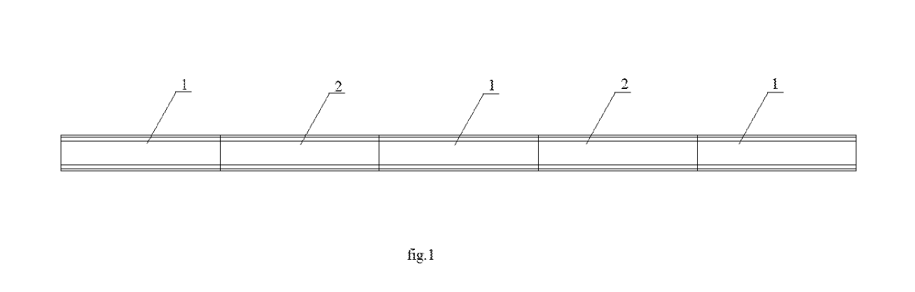

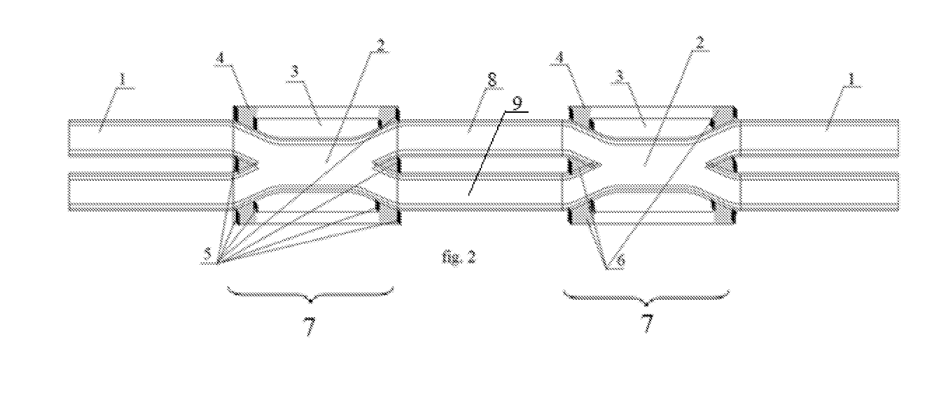

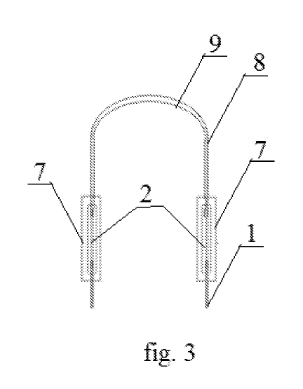

The fibre coupler for achieving high temperature-resistant interferometers and the high temperature-resistant interferometer have been depicted on FIG. 1, which shows the design of optical fibre constituting one of interferometer arms, FIG. 2, which shows the design of the interferometer according to the invention utilizing two fibre couplers, and FIG. 3, which shows the interferometer sensor achieved utilizing two fibre couplers according to the design.

### EXAMPLE I

The device, especially the fibre coupler for achieving interferometers containing optical fibres has them laid in parallel in an enclosure. Each optical fibre consists of sections 2 of optical fibre in a non-metallic coating between sections 1 in coatings with a melting point above 200° C. Individual sections 1 and 2 of the optical fibres are interconnected frontally by splicing. Mutually corresponding optical fibre sections (2) with a non-metallic coating are interconnected in a way, that their cores are close enough so as to enable optical signal propagation between optical fibres.

Interconnected (coupled) optical fibres are fixed to the substrate (3). The substrate (3) has the shape of a gutter or pipe and the fibres are fixed to it in the adjacent area in a permanent manner using a high-temperature adhesive 5. The coupled optical fibres together with the substrate 3, which they are attached to, are resting inside a capillary 4, glued to it using an adhesive 5 with a low thermal expansion index. The holes in the capillary 4, which the optical fibres run through are additionally sealed with a high-temperature resistant sealant 6.

Interferometer executed according to the invention contains fibre couplers 7, interconnected via optical fibre sections 1 with a metallic coating. Whereas optical fibre running through the fibre couplers are made of interconnected optical fibre sections 2 with a polymer coating, and outside of the capillary (4) optical fibre sections 1 with a high temperature-resistant metallic coating are permanently interconnected with sections 2 with a polymer coating and the length of the fibers (8) and (9) between the couplers (7) is different.

Fibre couplers are made by after splicing different coating types of optical fiber sections, in sequence: non-metallic, preferably polymer, high-temperature resistant, preferably metallic, and again non-metallic, preferably polymer, high-temperature resistant, preferably metallic, and again non-metallic, preferably polymer. The creation of fibre couplers utilizing the 2nd configuration enables maintaining small distances between fibre couplers, which is beneficial from the point of view of sensory operation.

1. Fibre coupler for creation of optical fibre-containing interferometers (sensors), with at least two parallel optical fibres placed in an enclosure characterized in that each of the optical fibres consists of at least three alternately placed light-conductive sections with different coatings, at least one (1) of which has a melting point above 200° C., and the two corresponding sections (2) with coating other than with a melting point above 200° C. are coupled using any known method.

2. Device according to claim 1 characterized in that each of the optical fibre contains sections (2) with a non-metallic coating in between sections (1) with coatings with a melting point above 200° C.

3. Device according to claim 1 characterized in that the coating with a melting point above 200° C. is metallic.

4. Device according to claim 1 characterized in that the optical fibre with coatings other than with a melting point above 200° C. are polymer-covered optical fibres.

5. Device according to claim 1 characterized in that individual optical fibre sections are interconnected frontally by splicing.

6. Device according to claim 1 characterized in that the mutually corresponding optical fibre sections (2) with a non-metallic coating are interconnected in a way, that their cores are close enough so as to enable optical signal propagation between optical fibres.

7. Device according to claim 1 characterized in that the interconnected (coupled) optical fibres are fixed to the substrate (3).

8. Device according to claim 7 characterized in that the substrate (3) is made of glass.

9. Device according to claim 7 characterized in that the substrate (3) has the shape of a gutter or pipe.

10. Device according to claim 7 characterized in that the optical fibers are permanently attached to the substrate (3) at least in the adjacent area in a permanent manner using a high-temperature adhesive (5) with a low thermal expansion index.

11. Device according to claim 7 characterized in that the coupled optical fibres together with the substrate (3), which they are attached to, are resting inside a capillary (4), glued to it using an adhesive (5), and the holes in the capillary (4), which the optical fibres run through are additionally sealed with a sealant (6).

12. Device according to claim 11 characterized in that the adhesive (5) is resistant to high temperatures.

13. Device according to claim 12 characterized in that the adhesive (5) is resistant to high temperatures and the capillary (4) is additionally sealed with a sealant (5), preferably silicone, silicone foam, rubber or soft resin.

14. Interferometer containing fibre couplers according to any of the above claims 1-13, each of with at least two parallel optical fibres placed in an enclosure characterized in that each of the optical fibres consists of at least three alternately placed light-conductive sections with different coatings, at least one (1) of which has a melting point above 200° C., and the two corresponding sections (2) with coating other than with a melting point above 200° C. are coupled using any known method, whereas the couplers are interconnected by at least two optical fibre sections with a high temperature-resistant coating.

15. Sensor according to claim 14 characterized in that the length of the optical fibers (8) and (9) between the couplers (7) is different.

16. Sensor according to claim 14 characterized in that the length of the optical fibers (8) and (9) between the couplers (7) is identical.

17. Sensor according to claim 14 characterized in that the high temperature-resistant coating is metallic.

18. Sensor according to claim 14 characterized in that the non-metallic coating is polymer.

19. (canceled)
